(19) United States
(12) Patent Application Publication
(10) Pub. No.: US 2015/0134360 A1
(43) Pub. Date: May 14, 2015

(54) Method for managing an electronic pillbox of a patient and a computer program product

(71) Applicant: CubiPharma inc., Montreal (CA)

(72) Inventors: Légaré Patrick, Montreal (CA); Landry Vincent, Montreal (CA)

(21) Appl. No.: 14/079,360

(22) Filed: Nov. 13, 2013

(51) Int. Cl. G06F 19/00

(52) U.S. Cl. CPC G06F 19/3456; G06F 19/322
USPC 705/3

(57) ABSTRACT

The present relates to a computer-implemented method for managing an electronic pillbox. The method generates a patient record and an electronic pillbox associated to the patient record. The electronic pillbox comprises at least one drug. The method generates for each drug in the electronic pillbox a medication schedule. The medication schedule comprises at least one period of the day, and a quantity of the drug to be taken for that period. The method also determines a period of time, generates an instance of the electronic pillbox for the determined period of time, and allocates a unique identifier to the instance of the electronic pillbox. The instance of the electronic pillbox comprises the medication schedule for the determined period of time for each drug in the electronic pillbox. The present also relates to a computer program product for implementing the method.

### TECHNICAL FIELD

The present disclosure relates to the field of pillbox preparation; and more particularly to a method for managing an electronic pillbox of a patient and to a corresponding computer program product.

### BACKGROUND

A pillbox is a container for storing the medication of a patient for a given period of time, for instance one week. The pillbox is designed so as to help the patient follow the medication schedule. For this purpose, the pillbox is generally divided into compartments. Each compartment corresponds to a specific day, and in some cases a specific period of the specific day (for example, Monday lunch, Monday supper, Tuesday lunch . . . ). Each compartment contains the medication (generally pills) to be taken at the corresponding specific period of the specific day.

Great care must be taken in the various steps of the preparation of the pillbox, in order to avoid errors, which may have serious consequences on the health of the patient. These steps include the creation by a pharmacist, based on a prescription, of a list of drugs. The list comprises for each drug a determined posology and a specific schedule for taking it. The steps also include the effective preparation (by a qualified technician) of the pillbox, by filling the compartments of the pillbox with the proper pills, based on the list of drugs. The steps further include the verification of the pillbox by a different qualified technician, or by the pharmacist himself in some cases.

Some of the steps may be automated. For instance, the filling of the pillbox with the proper pills may be automated, using a dedicated apparatus. Also, the creation of the list of drugs based on the prescription may be facilitated by a dedicated software program. However, the whole process of preparing pillboxes generally includes a lot of paperwork, and lacks a means for easily planning and monitoring the various steps of the preparation of each individual pillbox.

There is therefore a need for a method and computer program product for managing an electronic pillbox of a patient.

### SUMMARY

In accordance with a first aspect, the present disclosure relates to a method for managing an electronic pillbox of a patient. The method comprises generating by a processor a patient record. The method further comprises generating by the processor an electronic pillbox associated to the patient record. The electronic pillbox comprises at least one drug. The method also comprises generating by the processor for each drug in the electronic pillbox a medication schedule.

In accordance with a second aspect, the present disclosure relates to a computer program product comprising computer readable memory storing computer executable instructions thereon, that when executed by a computer, perform the aforementioned method.

In a particular aspect, the method further comprises determining by the processor a period of time, generating by the processor an instance of the electronic pillbox for the determined period of time, and allocating by the processor a unique identifier to the instance of the electronic pillbox.

### BRIEF DESCRIPTION OF THE DRAWINGS

Embodiments of the disclosure will be described by way of example only with reference to the accompanying drawings, in which:

FIGS. 1A and 1B illustrate a method for managing an electronic pillbox of a patient;

FIGS. 2-4 illustrate a graphical interface of a computer software implementing the method of FIG. 1; and

FIG. 5 illustrates a computer for executing the computer software implementing the method of FIGS. 1A and 1B.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to automating the planning and monitoring of various steps of the preparation of a pillbox of a patient.

### Terminology

### The following terminology is used throughout the present disclosure:

Patient record: data generated and stored on a computer, relating to a patient and a medical treatment of the patient.
Pillbox: a container having multiple compartments for storing the medication of a patient for a given amount of time (e.g. one week, two weeks, etc).
Electronic pillbox: data generated and stored on a computer for managing the different steps of the preparation of the pillbox. The data are applicable to all the pillboxes, which may be prepared over several periods of time (e.g. every week, every two weeks, etc).
Instance of an electronic pill box: data generated and stored on the computer for managing a specific pill box which will be prepared for a specific period of time according to the data of the electronic pill box. A unique identifier is used to identify the instance of the electronic pillbox and the corresponding specific pillbox.

In a first aspect, the present disclosure relates to a computer-implemented method for managing an electronic pillbox.

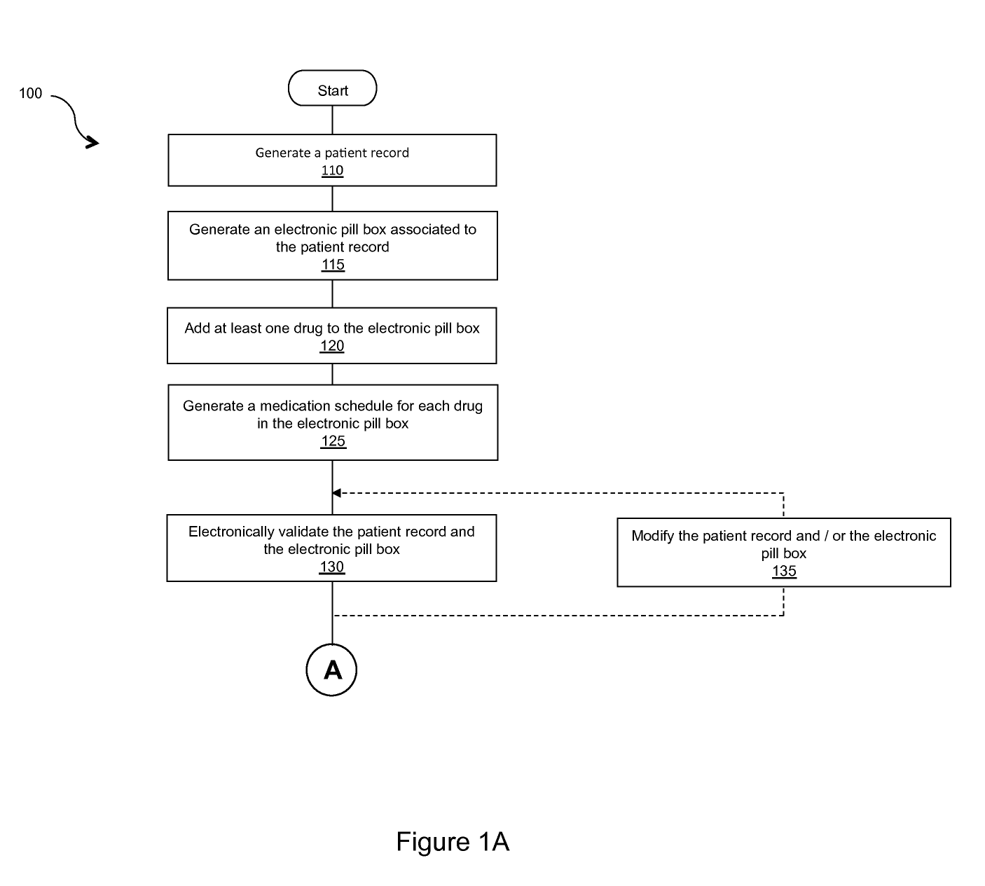

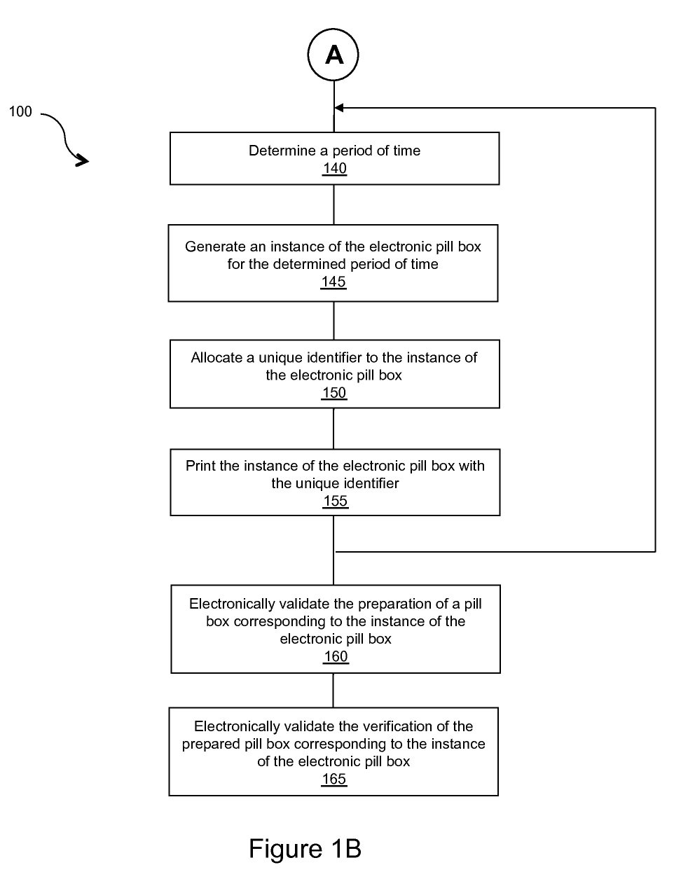

Referring now concurrently to FIGS. 1A-1B, FIGS. 2-4 and FIG. 5, a computer implemented method 100 for managing an electronic pillbox, a graphical interface 200 of computer software for managing an electronic pillbox, and a computer 500 are represented.

The computer software (not represented in the Figures) is executed by a processor 510 of the computer 500. The graphical interface 200 is displayed on a display 540 (generally a screen) of the computer 500, when the computer software is executed. The term computer is used in a generic manner. The computer 500 may include any fixed or mobile computing device, such as a traditional computer, a laptop, a tablet, a smartphone, etc. A user of the computer software executed by the processor 510 interacts with the graphical interface 200 via a user interface 550. The user interface 550 may include at least one of a keyboard, a mouse, a touchscreen, etc.

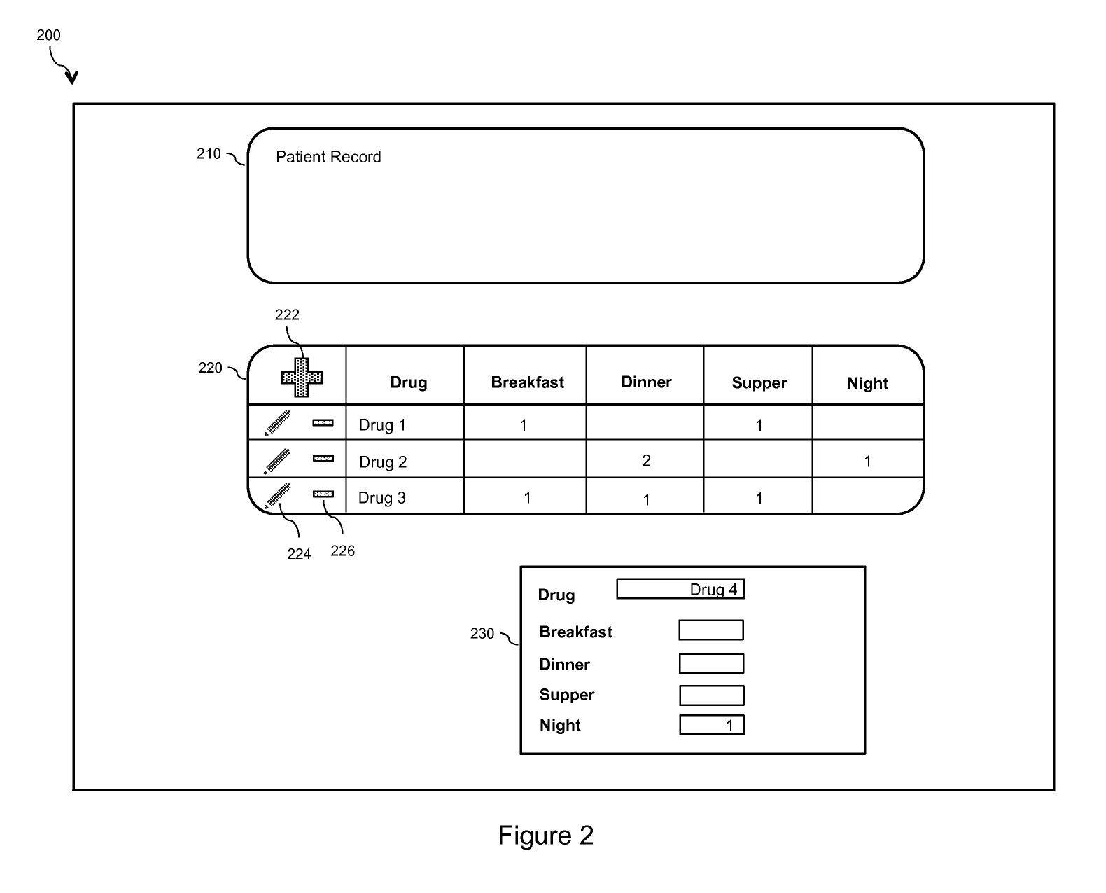

A first step in the management of an electronic pillbox consists in generating a patient record and the associated electronic pillbox. FIG. 2 illustrates this first step.

The method 100 comprises generating 110 by the processor 510 a patient record. The patient record comprises demographic data of the patient, such as: name, address, phone number, etc. The patient record also comprises data related to the treatment of the patient, and more specifically to the pillbox(es) which need to be prepared for the patient. For instance, the data may comprise a status of the patient (e.g. active, inactive, hospitalized, etc), a due day (day on which a pill box needs to be ready), a start day (day on which the patient is starting the treatment), a frequency of preparation of the pillbox(es) (e.g. only once, weekly, bi-weekly). The patient record may also comprise notes, which are displayed when a specific step in the preparation of a pillbox is reached (e.g. notes displayed when a pill box has been prepared or verified, notes displayed when a pill box has been delivered to the patient).

The user may interact with a pop up window (not represented in the Figures) with multiple fields displayed on the graphical interface 200 to create the patient record. The multiple fields are filled with appropriate data using the user interface 550 and the patient record is created based on these appropriate data. The completed patient record may be stored in a temporary (e.g. Random Access Memory (RAM)) and/or permanent (e.g. a hard drive) memory 520 of the computer 500. It may also be stored in the cloud (in a remote storage system (not represented in the Figures) accessed via a communication interface 530 of the computer 500 over a communication network such as the Internet). FIG. 2 illustrates the display of the completed patient record 210 in the graphical interface 200 (the data of the patient record 210 are not represented for simplification purposes).

The method 100 comprises generating 115 by the processor 510 an electronic pillbox associated to the patient record. An electronic pillbox comprises at least one drug. Thus, the method 100 further comprises adding 120 at least one drug to the electronic pillbox. FIG. 2 illustrates the display of an electronic pillbox 220 comprising three drugs (drug 1, drug 2 and drug 3) in the graphical interface 200. An icon 222 may be used to add a drug to the electronic pillbox 220. Then, the method 100 comprises generating 125 by the processor 510 a medication schedule for each drug in the electronic pillbox. The medication schedule comprises at least one period of the day (e.g. breakfast, dinner, supper and night) for taking the drug and a quantity of the drug (generally a number of pills) to be taken by the patient for that period. The electronic pill box 220 illustrates the following medication schedules: a pill of drug 1 shall be taken at breakfast and at supper; two pills of drug 2 shall be taken at dinner and one at night; one pill of drug 3 shall be taken at breakfast, at dinner and at supper. In the case where the posology is more complicated (the quantity of drug taken varies from one day to another), a calendar defining the quantities of drug to be taken every day may be used. The software program may be configured with four pre-defined periods (breakfast, dinner, supper, night) A user may also have the capability to add additional periods for a specific electronic pillbox or a specific drug of a pillbox. Additionally, the periods for taking a drug may be defined in the form of different hours of the day (e.g. 8 am, 11 am, 4 pm and 8 pm). The period may be defined between a starting date and an end date; the quantity of a drug may vary between even and odd days, or may be customized for each day. Alternatively, a sequence pattern over two or more days may be defined for taking a drug. For example, on the first day, a pill of the drug is taken at night; on the second day, two pills of the drug are taken at supper; and the sequence is repeated over a defined period of time from a starting date. Thus, the medication schedule can be customized for a specific drug or a specific electronic pillbox.

The user may interact with a pop up window 230 with multiple fields displayed on the graphical interface 200 to add a drug and its medication schedule to the electronic pillbox 220. When the user selects the icon 222, the popup window 230 is displayed and the user can select a drug (by entering its name or reference number, or selecting its name or reference number among a pre-defined list). The user can further enter the number of pills to be taken at breakfast, dinner, supper and night. The new drug (e.g. drug 4) and its medication schedule (e.g. one pill at night) are then added to the electronic pillbox 220.

The electronic pillbox 220 with its corresponding drug(s) and medication schedule(s) may be stored in the temporary and/or permanent memory 520 of the computer 500. It may also be stored in the cloud. Furthermore, the data related to the electronic pillbox 220 are linked to the data related to its corresponding patient record 210.

The sequence of execution of the steps 120 and 125 of the method 100 may vary. As illustrated in FIG. 2, when a drug is added to the electronic pillbox 220, the corresponding medication schedule is created simultaneously via the popup window 230. Alternatively, several drugs may be added to the electronic pillbox 220. Then, the corresponding medication schedules may be created in a following step.

The patient record 210 may have more than one associated electronic pillbox 220 (this use case is not represented in FIG. 2) generated and managed according to the method 100. For instance, if too many drugs must be taken by the patient at the same moment (e.g. four different drugs at dinner), two (or more) independent electronic pill boxes may be created. For example, a first electronic pillbox may contain the first two drugs to be taken at dinner, and a second electronic pillbox may contain the last two drugs to be taken at dinner. The other drugs to be taken at other periods of time may be added to any of the first and second electronic pillboxes. Alternatively, an additional dedicated electronic pillbox may be created for a specific type of medication (e.g. cytotoxic drugs).

A plurality of patient records is generated and managed according to the method 100, each patient record having one (or more) associated electronic pillbox.

The method 100 comprises electronically validating 130 by the processor 510 the patient record 210 and the associated electronic pillbox 220 with credentials of a user having validation privileges. For instance, the computer software may consist of a web portal, which can be securely accessed via the Hypertext Transfer Protocol Secure (HTTPS). An authorized user accesses the web portal by first providing a login (e.g. a username), a password, and optionally a pharmacy branch number. The login and password (and optionally the pharmacy branch number) constitute the credentials of the user. The credentials enable to uniquely identify the user, and to allocate him proper execution rights corresponding to a specific user profile (e.g. pharmacist, preparation technician, verification technician, system administrator, etc). The web portal is configured with the profiles of all the users, and more specifically with a list of all the users having validation privileges. Thus, a user with validation privileges may display a particular patient record 210 (identified by the patient name) and the associated electronic pillbox 220. The user may further verify the validity of the data of the patient record 210 and the associated electronic pillbox 220. Finally, the user may validate the patient record 210 and the associated electronic pillbox 220 with validation means (not represented in the Figures) displayed in the graphical interface 200. For example, the validation means may consist of a validation icon. The validation icon is displayed only for a user having validation privileges. Once the validation has been performed via the validation icon, the day and time of occurrence of the validation is memorized, as well as the credentials of the user who performed the validation. It is usually sufficient to memorize the user name (and not the complete credentials), which is generally unique among the users of the web portal. Thus, the web portal provides a traceability of when and by which user the particular patient record 210 and associated electronic pillbox 220 have been validated.

The method 100 comprises the optional step of modifying 135 by the processor 510 the patient record 210 and/or the associated electronic pillbox(es) 220. The modifications to the electronic pillbox 220 comprise adding a drug to the electronic pillbox 220. The addition has already been described and may be performed via interactions with the icon 222 and a further displayed popup window 230. The modifications to the electronic pillbox 220 also comprise removing a drug from the electronic pillbox 220. The removal may be performed via an icon 226 allowing the removal of a specific drug (e.g. drug 3) from the electronic pillbox 220. The modifications to the electronic pillbox 220 further comprise modifying the medication schedule of a drug of the electronic pillbox 220. The schedule modification may be performed via an icon 224 triggering the display of a popup window similar to the popup window 230, where the medication schedule of the selected drug (e.g. drug 3) can be modified. Modifications to data of the patient record 210 may also be performed by appropriate interactive means displayed in the graphical interface 220. For example a popup window providing fields where the current values of the data of the patient record 210 are displayed and can be modified.

Once a modification to the patient record 210 or to the associated electronic pillbox(es) 220 has occurred, the electronic validation performed at step 130 of the method 100 is cancelled, and shall be performed again with credentials of a user having validation privileges.

The method 100 may also comprise the step (not represented in FIG. 1A) of generating by the processor 510 an history of all the modifications to a particular patient record 210 and to the associated electronic pillbox(es) 220. Thus, the web portal provides a traceability of all the modifications performed on all the patient records (and their associated electronic pillboxes) managed by the web portal. For this purpose, all the modifications to a particular patient record 210 and to the associated electronic pillbox(es) 220 are recorded in the memory 520. A user may then request a display of all the recorded modifications that occurred between two dates. A user may also request a display of a comparison of a current version of a particular patient record 210 and associated electronic pillbox(es) 220 with the last recorded version.

The method 100 may also allow the replacement of a particular drug by another drug for all the electronic pillboxes of all the patients for which the particular drug (e.g. drug 2) was present in the medication schedule of the electronic pillboxes 220.

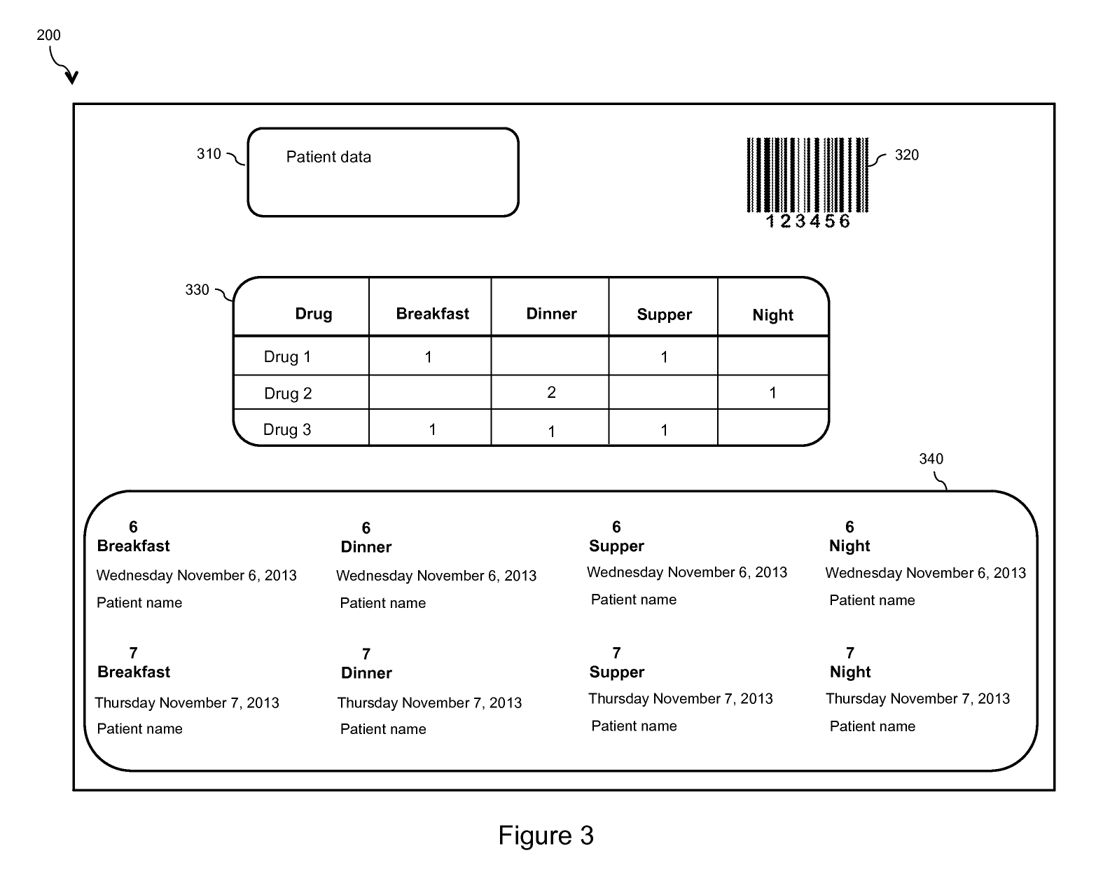

A second step in the management of an electronic pillbox consists in generating instance(s) of the electronic pillbox. FIG. 3 illustrates this second step.

A plurality of patient records and associated electronic pillboxes has been created by the processor 510 and stored in the memory 520. The user can generate an instance of an electronic pillbox corresponding to one of the created electronic pillboxes. For this purpose, the user selects the patient record of a specific patient (identified by demographic data such as its name). If the patient record comprises several electronic pillboxes, the user selects one among them. The selection is performed via interactions of the user with the graphical interface 200 which are not represented in the Figures (e.g. selection among a displayed list of patients and optionally among a displayed list of electronic pillboxes). Data of the selected patient record and selected electronic pillbox may be displayed in the graphical interface 200 for validation purposes, before the generation of the instance of the electronic pillbox. The generation of the instance is performed via the following steps of the method 100.

The method 100 comprises determining 140 by the processor 510 a period of time. For instance, the user may select a starting week and a number of days. The number of days generally consists of 7, 14, 21 or 28 days; but may also be less than 7 days. Based on the starting week, the number of days and the treatment start day, the processor 510 determines the period of time, which consists of the days when drugs from the pillbox shall be taken by the patient. For example, if the starting week is the week corresponding to Monday Nov. 4, 2013; the number of days is 14; and the treatment start day is Wednesday Nov. 6, 2013; then the period of time is Wednesday Nov. 6, 2013 to Sunday Nov. 17, 2013.

The method 100 comprises generating 145 by the processor 510 an instance of the electronic pillbox for the determined period of time and allocating 150 by the processor 510 a unique identifier to the instance of the electronic pillbox. The instance of the electronic pillbox comprises data allowing the preparation and the verification of a specific pillbox. The specific pillbox is prepared for the determined period of time according to the data of the electronic pillbox. The data of the instance of the electronic pillbox may include a reference to the electronic pillbox, the determined period of time, and the unique identifier. The instance of the electronic pillbox may also include the medication schedule for the determined period of time for each drug in the electronic pillbox. Thus, if the medication schedule of the electronic pillbox is modified later, it can be compared with the medication schedule of the current instance of the electronic pillbox and a mismatch can be detected. If a mismatch is detected, a new instance based on the new medication schedule of the electronic pillbox can be generated; and if a pillbox corresponding to the current instance has been prepared, it can be replaced before delivery to the patient. The instance of the electronic pillbox may further include data related to the patient, extracted from the data of the corresponding patient record. The instance of the electronic pillbox may be stored in the temporary and/or permanent memory 520 of the computer 500. It may also be stored in the cloud.

The unique identifier uniquely identifies the instance of the electronic pillbox. The unique identifier may be printed on the specific pillbox prepared according to the data of the instance of the electronic pillbox, in order to easily match the specific pillbox with the corresponding instance. The unique identifier may consist of a barcode.

FIG. 3 illustrate the data of the instance of the electronic pillbox, which may be displayed on the graphical interface 200. The data include the patient data 310 (extracted from the patient record 210), the unique identifier 320, the medication schedule 330 for each drug (e.g. drug 1, drug 2 and drug 3) of the electronic pillbox 220, and the determined period of time 340. For each day of the determined period of time 340, the periods of the day when drugs shall be taken by the patient are indicated, and can be correlated with the medication schedule 330. A preparation technician can use the data of the instance of the electronic pillbox displayed on the graphical interface 200 to prepare the specific pillbox corresponding to the instance. The data may also be printed by the processor 510 on a printer (not represented in the Figures). Thus, the method 100 comprises the optional step of printing 155 the instance of the electronic pillbox. A printed copy of the instance of the electronic pillbox may have all the information represented in FIG. 3, or only a subset, but shall include the unique identifier 320. As previously mentioned, the unique identifier 320 is used to easily correlate the instance of the electronic pillbox stored on the computer 500 with the printed copy of the instance and the prepared pillbox. A photo (not represented in the Figures) of the patient may also be included in the instance of the electronic pillbox (the photo has been added to the patient record 210 during its creation). Similarly, a photo of each drug present in the medication schedule of the instance of the electronic pillbox may be included. The photos may be appended to the corresponding pillboxes along with the medication schedule, to facilitate the identification of the drugs by the patients. The photo of each drug present in the medication schedule of the instance of the electronic pillbox may also be used by the technicians to facilitate visually confirming the drugs incorporated in the pillbox, or by care providers distributing drugs in the pillbox to patients.

The order of the drugs appearing in the instance of the electronic pillbox (in the medication schedule 330) may be modified with respect to the order of the drugs appearing in the corresponding electronic pillbox 220. The modification is performed via an interaction of the user with the graphical interface 200 not represented in the Figures.

When generating the instance of the electronic pillbox for the determined period of time, the processor 510 may determine that a previous instance has already been generated. The processor 510 may warn the user via the graphical interface 200 and allow him to choose between proceeding with/cancelling the generation of the new instance. If the new instance is generated, the previous instance is cancelled and the new instance is allocated a new unique identifier (different from the unique identifier of the previous instance). This situation may occur if the previous instance has been generated for the determined period of time, the electronic pillbox is then modified (e.g. drug added or removed, medication schedule of a drug modified), the modified electronic pillbox is validated, and a new instance based on the modified electronic pillbox is generated for the determined period of time.

A user may also have the capability to generate a plurality of instances of electronic pillboxes simultaneously. The processor 510 determines at least one selection parameter for selecting the electronic pillboxes for which an instance shall be generated. There may be a single or several selection parameters, and one of them is a period of time. The determination by the processor 510 is based on inputs from the user. For example, the user may first select a starting week and a number of days for determining the period of time (the days when drugs from the pillboxes shall be taken by the patient) for generating the instances of the electronic pillboxes. The determination of the period of time is similar to the one previously described when generating a single instance; but in the present case, a specific period of time is determined for each instance (since the corresponding patient records may have different treatment start days). The user may then select a specific day for the pillboxes due date. The processor 510 determines the electronic pillboxes having a pillbox due date matching this specific day, by selecting the patient records having a pillbox due day and preparation frequency matching the specific day. The user may also use an additional parameter for selecting patients with specific characteristics. The processor 510 filters the currently determined electronic pillboxes, selecting those for which the data of the patient record match the additional parameter (e.g. location of the patient, patient at home or in a hospital, etc).

Then, the processor 510 generates a plurality of instances of electronic pillboxes corresponding to the determined pillboxes matching the at least one selection parameter. The generation of the plurality of instances is similar to the previously described generation of a single instance, using the specific period of time determined for each specific electronic pillbox to generate the corresponding instance. The processor 510 further allocates a unique identifier to each generated instance of the electronic pillboxes.

The user may have the possibility to manually (via an interaction with the user interface 550) withdraw electronic pillboxes from the list of candidate electronic pillboxes for which an instance shall be generated.

The data in the instances of the electronic pillboxes may be converted in a compatible electronic format, and transmitted to a robot for automatic preparation of the corresponding pillboxes. The data in the instances of the electronic pillboxes may also be synchronized with data generated by computer software dedicated to the management of the pharmacy.

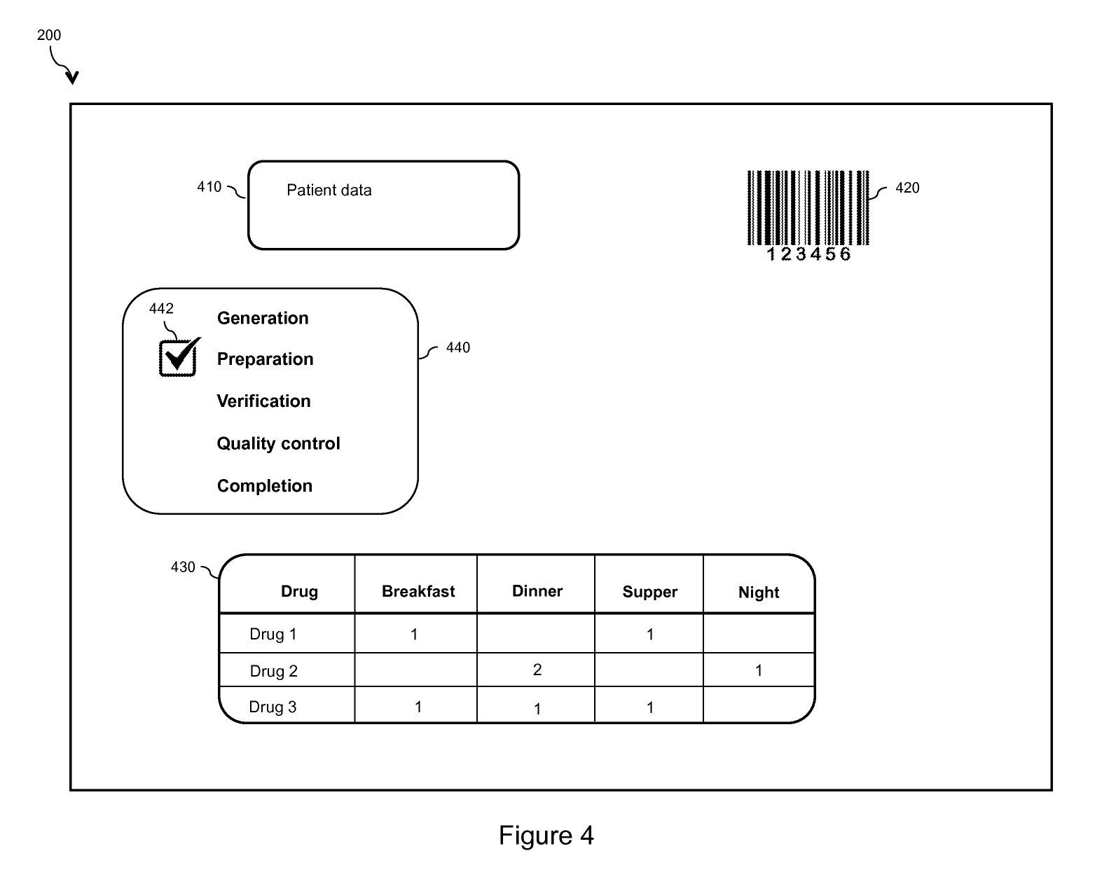

A third step in the management of an electronic pillbox consists in managing a generated instance of the electronic pillbox. FIG. 4 illustrates this third step.

Once an instance of the electronic pillbox has been generated, a preparation technician can prepare a pillbox based on the data of the instance of the electronic pillbox. The technician may use a printed copy of the instance of the electronic pillbox or data displayed on the graphical interface 200 as illustrated in FIG. 3. The instance to be prepared is identified by its unique identifier. When the preparation of the pillbox is completed, it is electronically validated.

The method 100 comprises electronically validating 160 by the processor 510 with credentials of a user having preparation privileges, that a pillbox corresponding to the instance of the electronic pillbox has been prepared. The instance of the electronic pillbox is identified by its unique identifier. The electronic validation of the preparation is similar to the previously described electronic validation of the patient record and associated electronic pillbox. The preparation technicians working in a pharmacy generally have the preparation privileges for performing the electronic validation of the preparation.

A user with preparation privileges provides the unique identifier of the instance of the electronic pillbox to the computer software via the user interface 550, and a validation screen as illustrated in FIG. 4 is displayed on the graphical interface 200. The validation screen may comprise patient data 410 (corresponding to the patient record 210 of the electronic pillbox). The validation screen comprises the unique identifier 420 of the instance of the electronic pillbox. The validation screen may comprise the medication schedule 430 for each drug of the electronic pillbox. The validation screen comprises a validation interface 440. The user with preparation privileges may electronically validate the preparation phase by selecting a preparation check box 442. The preparation check box 442 is displayed only to a user with preparation privileges, when the generation of the instance of the electronic pillbox has been completed, and when the preparation phase has not been electronically validated yet.

When the electronic validation of the preparation has been performed, the day and time of occurrence of the electronic validation is memorized, as well as the credentials (e.g. name) of the user who performed the electronic validation. Thus, there is provided a traceability of when and by which user the electronic validation was performed.

Once a pillbox has been prepared and electronically validated, a verification technician can verify the pillbox by comparing its content with data of the corresponding instance of the electronic pillbox. The technician may use a printed copy of the instance of the electronic pillbox or data displayed on the graphical interface 200 as illustrated in FIG. 3. When the verification of the pillbox is completed, it is electronically validated.

The method 100 comprises electronically validating 165 by the processor 510 with credentials of a user having verification privileges, that a pillbox corresponding to the instance of the electronic pillbox has been verified. The instance of the electronic pillbox is identified by its unique identifier. The electronic validation of the verification is similar to the previously described electronic validation of the preparation. The verification technicians working in a pharmacy generally have the verification privileges for performing the electronic validation of the verification. Technicians may have privileges for performing both the electronic validation of the preparation and the verification. However, for a given pillbox, each technician only has either validation of the preparation or verification privileges. Only pharmacists may have both privileges for a given pillbox.

A user with verification privileges provides the unique identifier of the instance of the electronic pillbox to the computer software via the user interface 550, and a validation screen similar to the one illustrated in FIG. 4 is displayed on the graphical interface 200. The only difference is that the check box 442 is for electronically validating the verification (verification check box) instead of the preparation (preparation check box).

The user with verification privileges may electronically validate the verification phase by selecting the verification check box. The verification check box is displayed only to a user with verification privileges, when the preparation phase has been electronically validated by another user (except for pharmacists), and when the verification phase has not been electronically validated yet.

When the electronic validation of the verification has been performed, the day and time of occurrence of the electronic validation is memorized, as well as the credentials (e.g. the name) of the user who performed the electronic validation. Thus, there is provided a traceability of when and by which user the electronic validation was performed.

A particular verification procedure may be implemented for a specific type of drug, for instance for warfarin (warfarin is an anticoagulant). If an instance of an electronic pillbox contains warfarin, the corresponding pillbox shall be verified according to the particular verification procedure. Then, a specific electronic validation may be performed by a user with proper verification privileges, to validate that the particular verification has been performed. The specific electronic validation of the particular verification procedure (of warfarin) is similar to the electronic validation of the standard verification procedure (for other drugs than warfarin).

FIG. 4 illustrates other phases, which may be electronically validated with credentials of a user having appropriate privileges. Such phases include transfer, quality control and completion. Transfer is an indicator which allows a pillbox request to be transferred to another pharmacy for preparation. Quality control is an optional phase occurring after the verification phase, for pillboxes containing specific types of drugs (e.g. drugs which may present critical risks to the health of the patient if not used with the appropriate posology). The users having quality control privileges may be users with higher qualifications, such as pharmacists. A percentage of pillboxes, which have to go trough a quality control may be automatically calculated based on a specific protocol of a specific pharmacy, and/or based on established protocols including lots of pillboxes and minimum quality control percentages, etc. Furthermore, pillboxes, which need to go through the quality control process, may be automatically determined (by automatically selecting the corresponding instances of electronic pillboxes). Completion is a phase occurring after the verification phase (or optionally after the quality control phase). This phase corresponds to a pillbox ready to be delivered to the patient, or alternatively to a pillbox which has been delivered to the patient.

The processor 510 may determine a current state of the instance of the electronic pillbox (among a pre-defined set of states), and manage the transitions between the states. For instance, the state is initially set to ‘generated’, when an instance of the electronic pillbox has been generated. After electronic validation of the preparation of the corresponding pillbox, the current state becomes prepared. After electronic validation of the verification of the corresponding pillbox, the current state becomes verified. The processor 510 controls the actions (e.g. electronic validation of the verification), which can be performed in a specific state (e.g. prepared), and by which users (users with verification privileges). Two additional states corresponding to the quality control and to the completion may be determined and managed by the processor 510.

The method 100 may also comprise generating by the processor 510 a dashboard and displaying the dashboard on the graphical interface 200, to show the state in which instances of electronic pillboxes are (to follow the progression in the preparation of the corresponding pillboxes). For instance, the dashboard may show the state of all the instance of the electronic pillboxes, which have a due date within a determined week.

At each state associated to the instance of the electronic pillbox, modifications to the patient record and to the electronic pillbox may be notified to the user (e.g. drug added or removed, medication schedule of a drug modified). The notification identifies the differences between the pillbox instance and the electronic pillbox. The notification may occur when the user generates the electronic signature corresponding to a particular phase. For instance, if a preparation technician has prepared a pillbox and initiates the procedure for electronically validating the preparation phase, a modification to the patient record or to the electronic pillbox is notified to the user. Then, a new instance of the electronic pillbox may be generated (based on up to date data), automatically cancelling the previous instance of the electronic pillbox. A new pillbox can be prepared, based on the new instance, and the preparation phase can be further electronically validated.

The method 100 may also comprise generating by the processor 510 an incident record. The incident record describes an error that occurred in the preparation of a pillbox corresponding to an instance of an electronic pillbox (identified by its unique identifier). The term preparation is meant to have a large meaning and encompasses the various phases of the lifecycle of the pillbox (e.g. preparation, verification, quality control, completion, etc). The incident record is memorized in the memory 520. The incident record may comprise: a type of incident, a unique identifier of the instance of the electronic pillbox, the state at which the incident occurred, a drug from the instance of the electronic pillbox for which the incident occurred, and a user responsible for the incident. For example, an incident record may be generated during the verification phase, when a verification technician determines that the pillbox contains a wrong quantity of a specific drug when compared to the medication schedule of the corresponding instance of the electronic pillbox.

When an incident record is generated, the error shall be corrected and the correction electronically validated by a user with appropriate privileges (e.g. a pharmacist). The electronic validation of the correction allows proceeding with the current phase. As long as the correction of the error is not electronically validated, the current phase is in stand-by (e.g. it cannot be electronically validated).

The method 100 may further comprise generating reports on the incident records that have been memorized. A report may identify all the incident records for which a specific user is responsible. A report may also identify all the incident records generated for a specific drug. A report may further identify all the incident records corresponding to a specific patient. A report may also identify all the incident records occurring on one or several specific dates. Additionally, a report may identify the users, drugs or patients, which are more frequently involved in incident records.

Reports may also be generated with respect to: patients based on the drugs present in their pillboxes (each pillbox has a corresponding instance of an electronic pillboxes), inventory of the drugs present in the pillboxes, inventory of narcotic drugs present in the pillboxes.

The method 100 may also include the generation and impression of a drug administrative file of a patient; and the management and customization of the data in this file. Access to the file is only granted to healthcare persons authorized by the patient. The file may be accessed for consultation purposes, to electronically register the delivery of drugs to the patient, and to manage the authorizations given by the patient to share medical data of the file. The drug administrative file may be a separate function from the pillbox, or part thereof. Access to the drug administrative file may be granted electronically by any means known in the art, or in paper format in relation to the pillbox.

Reminders of the drug schedules may be transmitted to the patient by appropriate communications means (e.g. e-mails, Short Message Service (SMS)).

The method 100 may also include the reception and management of orders for narcotic products used for medication purposes. The narcotic products are identified by an Universal Product Code (UPC) or a Drug Identification Number (DIN). The narcotic products are registered by bill number and provider. Electronic validation by a user with appropriate validation privileges is used for managing the narcotic products inventory. Sells, returns and loss of narcotic products over a given period of time are recorded. Furthermore, differences between a theoretical inventory registered in the system and a real inventory in a pharmacy are detected and reported. Additionally, reports related to the inventory of narcotic products may be automatically generated and transmitted to government agencies.

In a second aspect, the present disclosure relates to a computer program product for managing an electronic pillbox.

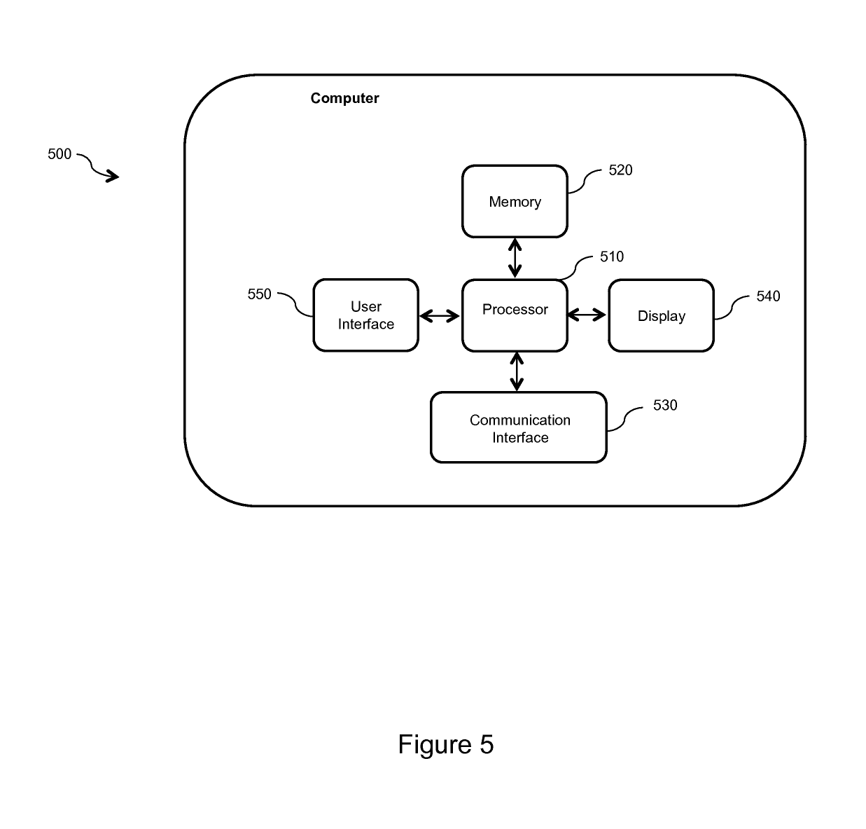

Referring now concurrently to FIGS. 1A, 1B and 5, the computer program product comprises the computer readable memory 520 of the computer 500. The computer readable memory 520 stores computer executable instructions thereon. When executed by the processor 510 of the computer 500, the computer executable instructions perform the aforementioned method 100 for managing an electronic pillbox.

In an alternative embodiment, the computer program product comprises a computer readable memory located in another computer (not represented in FIG. 5) for storing the computer executable instructions thereon. The computer executable instructions are transmitted from the other computer to the computer 500 over a communication network (not represented in FIG. 5). The computer 500 comprises a communication interface 530 for receiving the computer executable instructions from the other computer. The received computer executable instructions are executed by the processor 510 of the computer 500.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for managing an electronic pillbox of a patient, the method comprising:
generating by a processor a patient record;
generating by the processor an electronic pillbox associated to the patient record, the electronic pillbox comprising at least one drug; and
generating by the processor for each drug in the electronic pillbox a medication schedule.

2. The method of claim 1, wherein the patient record comprises demographic data of the patient, a pillbox due day, a treatment start day, and a preparation frequency.

3. The method of claim 1, wherein generating the medication schedule comprises determining at least one period of the day for taking the drug and a quantity of the drug to be taken by the patient for that period.

4. The method of claim 1 further comprising:
electronically validating by the processor the patient record and the associated electronic pillbox with credentials of a user having validation privileges.

5. The method of claim 1 further comprising:
modifying by the processor at least one of: the patient record and the associated electronic pillbox.

6. The method of claim 5, wherein modifying the electronic pillbox comprises at least one of: adding a drug to the electronic pillbox, removing a drug from the electronic pillbox, and modifying the medication schedule of a drug in the electronic pillbox.

7. The method of claim 5 further comprising:
electronically validating by the processor the modification with credentials of a user having validation privileges.

8. The method of claim 5 further comprising:
generating by the processor an history of the modifications.

9. The method of claim 1 further comprising:
determining by the processor a period of time;
generating by the processor an instance of the electronic pillbox for the determined period of time; and
allocating by the processor a unique identifier to the instance of the electronic pillbox.

10. The method of claim 9 wherein the instance of the electronic pillbox comprises the medication schedule for the determined period of time for each drug in the electronic pillbox.

11. The method of claim 9 further comprising:
printing by the processor the instance of the electronic pillbox with the unique identifier.

12. The method of claim 9, wherein the unique identifier consists of a barcode.

13. The method of claim 9 further comprising:
determining by the processor that an instance of the electronic pillbox has already been generated for the determined period of time.

14. The method of claim 9 further comprising
electronically validating by the processor with credentials of a user having preparation privileges that a pillbox corresponding to the instance of the electronic pillbox has been prepared, the instance of the electronic pillbox being identified by its unique identifier.

15. The method of claim 14 further comprising:
electronically validating by the processor with credentials of a user having verification privileges that the prepared pillbox corresponding to the instance of the electronic pillbox has been verified, the instance of the electronic pillbox being identified by its unique identifier.

16. The method of claim 15 further comprising:
determining by the processor a state of the instance of the electronic pillbox, the states of the instance of the electronic pillbox including any of the following: generated, transferred, prepared, quality controlled general, quality control specific, validated, verified and completed.

17. The method of claim 16 further comprising:
generating by the processor an incident record, the incident record comprising: a type of incident, the unique identifier of the instance of the electronic pillbox, the state at which the incident occurred, a drug from the instance of the electronic pillbox for which the incident occurred, and a user responsible for the incident.

18. The method of claim 1 further comprising:
generating by the processor a plurality of patient records; and
generating by the processor for each patient record at least one associated electronic pillbox.

19. The method of claim 18 further comprising:
determining by the processor at least one selection parameter, the at least one selection parameter comprising a period of time;
generating by the processor a plurality of instances of electronic pillboxes corresponding to the at least one selection parameter; and
allocating by the processor a unique identifier to each instance of the electronic pillboxes.

20. A computer program product comprising a computer readable memory storing computer executable instructions thereon that, when executed by a computer, perform the method of claim 1.
